(19) United States
(12) Patent Application Publication
(10) Pub. No.: US 2012/0241061 A1
(43) Pub. Date: Sep. 27, 2012

(54) HEAVY DUTY PNEUMATIC TIRE

(76) Inventor: Atsushi MAEHARA, Kobe-shi (JP)

(21) Appl. No.: 13/428,758

(22) Filed: Mar. 23, 2012

(30) Foreign Application Priority Data
Mar. 25, 2011 (JP) 2011-068391

(51) Int. Cl. B60C 11/13

(52) U.S. Cl. 152/209.22

(57) ABSTRACT

A heavy duty pneumatic tire is provided in the tread portion with six land portions (crown, middle and shoulder) divided axially by five main grooves. Each land portion is divided into blocks by axial grooves (crown, middle and shoulder). Each axial groove is provided with a tie bar. The tie bar in the shoulder axial groove is largest in the protruding height. The maximum widths Wcr, Wmi and Wsh of the crown, middle and shoulder land portions satisfy; 0.9=<Wmi/Wcr=<0.98 and 1.1=<Wsh/Wcr=<1.22.

### BACKGROUND OF THE INVENTION

The present invention relates to a pneumatic tire, more particularly to a heavy duty pneumatic tire having a tread pattern capable of improving uneven wear such as center wear and heel-and-toe wear.

In the heavy duty pneumatic tires for truck, bus and the like as all-season tires suitable for driving on wet and dry pavements as well as driving in light snow, block-type tread patterns are widely employed to increase the traction in wet conditions and snow conditions. Such heavy duty pneumatic tires are often used under a very high tire pressure and very heavy tire loads. As a result, due to the variation of the tire load, so called center wear (crown blocks in the tread crown portion wear more than shoulder blocks in the tread shoulder regions) and heel-and-toe wear of shoulder blocks are liable to occur. These types of uneven wear are liable to occur on the tires on the drive axle rather than the tires on the steering axle.

If the crown blocks are increased in the rigidity, since the shoulder blocks are relatively decreased in the rigidity, the heel-and-toe wear increases. Conversely, if the shoulder blocks are increased in the rigidity, since the crown blocks are relatively decreased in the rigidity, the center wear increases.

### SUMMARY OF THE INVENTION

It is therefore, an object of the present invention to provide a heavy duty pneumatic tire, in which both of the center wear in the tread crown region and the heel-and-toe wear of the shoulder blocks can be improved to high levels.

According to the present invention, a heavy duty pneumatic tire comprises

a tread portion provided with circumferentially continuously extending main grooves including a center main groove on the tire equator, a pair of middle main grooves one on each side of the center main groove, and a pair of shoulder main grooves one on the axially outside of each of the middle main grooves, so as to define a pair of crown land portions between the center main groove and the middle main grooves, a pair of middle land portions between the middle main grooves and the shoulder main grooves, and a pair of shoulder land portions between the shoulder main grooves and tread edges,

the crown land portions, the middle land portions and the shoulder land portions are divided into crown blocks, middle blocks and shoulder blocks by crown axial grooves, middle axial grooves and shoulder axial grooves, respectively,

the crown axial grooves, the middle axial grooves and the shoulder axial grooves are provided with crown tie bars, middle tie bars and shoulder tie bars, respectively, wherein each tie bar protrudes from the groove bottom to connect the circumferentially adjacent blocks,

the shoulder tie bars are largest in the protruding height,

the maximum width Wcr of the crown land portion, the maximum width Wmi of the middle land portion, and the maximum width Wsh of the shoulder land portion satisfy the following relationship:

0.9=<Wmi/Wcr=<0.98 and

1.1=<Wsh/Wcr=<1.22.

The heavy duty pneumatic tire according to the present invention may be further provided with the following optional features:

the ratio Wsh/Wmi is 1.12 to 1.36;

the midpoint of the maximum axial length of the crown tie bar is positioned in an axial central part of the crown axial groove, the midpoint of the maximum axial length of the middle tie bar is positioned in an axial central part of the middle axial groove, and the midpoint of the maximum axial length of the shoulder tie bar is positioned in an axial outside part of the shoulder axial groove;

the maximum protruding height of the shoulder tie bar is 70 to 85% of the maximum groove depth of the shoulder main groove;

the crown blocks, the middle blocks and the shoulder blocks are each provided in a circumferential central region thereof with an axially extending sipe;

the difference between the shoulder lateral groove depth at the shoulder tie bar and the maximum depth of the sipe of the shoulder block is not less than 30% of the maximum groove depth of the shoulder main groove.

Therefore, the tie bars in each land portion decrease the rigidity variation in the land portion along the tire circumferential direction and the resistance to heel-and-toe wear can be improved. Further, as the shoulder tie bars have the largest protruding height, the heel-and-toe wear and shoulder wear being liable to occur in the shoulder land portions can be effectively prevented. Since the ratios Wmi/Wcr and Wsh/Wcr satisfy the specific conditions, the crown blocks subjected to a relatively large ground pressure are increased in the rigidity, and thereby, the resistance to the center wear can be improved. In addition, the shoulder blocks are also provided with rigidity capable of preventing the heel-and-toe wear and shoulder wear.

As a result, in the heavy duty pneumatic tire according to the present invention, both of the center wear and heel-and-toe wear can be improved to high levels.

In this application including specification and claims, various dimensions, positions and the like of the tire refer to those under a normally inflated unloaded condition of the tire unless otherwise noted.

The normally inflated unloaded condition is such that the tire is mounted on a standard wheel rim and inflate to a standard pressure but loaded with no tire load.

The undermentioned normally inflated loaded condition is such that the tire is mounted on the standard wheel rim and inflate to the standard pressure and loaded with the standard tire load.

The standard wheel rim is a wheel rim officially approved or recommended for the tire by standards organizations, i.e. JATMA (Japan and Asia), T&RA (North America), ETRTO (Europe), TRAA (Australia), STRO (Scandinavia), ALAPA (Latin America), ITTAC (India) and the like which are effective in the area where the tire is manufactured, sold or used. The standard pressure and the standard tire load are the maximum air pressure and the maximum tire load for the tire specified by the same organization in the Air-pressure/Maximum-load Table or similar list. For example, the standard wheel rim is the “standard rim” specified in JATMA, the “Measuring Rim” in ETRTO, the “Design Rim” in TRA or the like. The standard pressure is the “maximum air pressure” in JATMA, the “Inflation Pressure” in ETRTO, the maximum pressure given in the “Tire Load Limits at Various Cold Inflation Pressures” table in TRA or the like. The standard load is the “maximum load capacity” in JATMA, the “Load Capacity” in ETRTO, the maximum value given in the above-mentioned table in TRA or the like.

The tread edges 2t are the axial outermost edges of the ground contacting patch (camber angle=0) in the normally inflated loaded condition.

### BRIEF DESCRIPTION OF THE DRAWINGS

FIG. 1 is a developed partial view of the tread portion of a heavy duty pneumatic tire according to an embodiment of the present invention.

FIG. 2 is a cross sectional view of the tread portion taken along line A-A of FIG. 1.

FIG. 3 is a partial top view of the crown land portion thereof.

FIG. 4 is a partial top view of the middle land portion thereof.

FIG. 5 is a partial top view of the shoulder land portion thereof.

FIG. 6 is an enlarged cross sectional view taken along line B-B of FIG. 1.

### DESCRIPTION OF THE PREFERRED EMBODIMENTS

Embodiments of the present invention will now be described in detail in conjunction with the accompanying drawings.

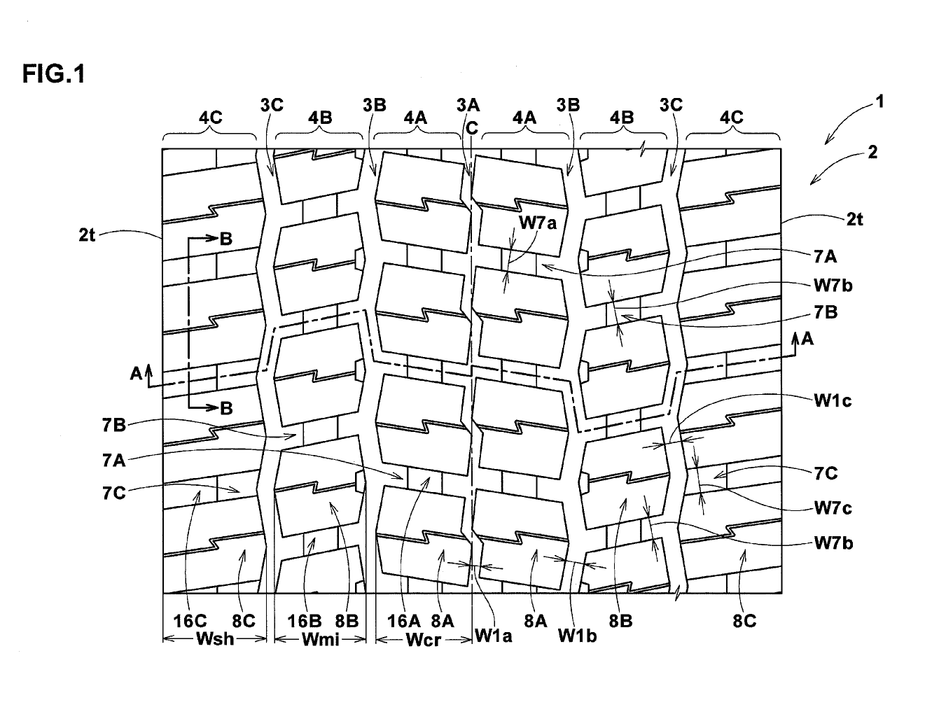

In the drawings, heavy duty pneumatic tire 1 according the present invention is a truck/bus tire having a block-based tread pattern as shown in FIG. 1.

The heavy duty pneumatic tire 1 comprises a tread portion 2, a pair of sidewall portions, a pair of axially spaced bead portions each with a bead core therein, a carcass extending between the bead portions through the tread portion and sidewall portions and secured to the bead cores, and a tread reinforcing belt disposed radially outside the carcass in the tread portion as usual.

In this embodiment, five circumferentially extending main grooves 3A, 3B and 3C are disposed in the tread portion 2, which include a center main groove 3A disposed on the tire equator C, a middle main groove 3B disposed on each side of the center main groove 3A, and a shoulder main groove 3C disposed axially outside each of the middle main grooves 3B. Accordingly, the tread portion 2 is axially divided into a pair of crown land portions 4A between the center main groove 3A and the middle main grooves 3B, a pair of middle land portions 4B between the middle main grooves 3B and the shoulder main grooves 3C, and a pair of shoulder land portions 4C between the shoulder main grooves 3C and the tread edges 2t.

In this embodiment, the center main groove 3A, middle main grooves 3B and shoulder main grooves 3c are each formed as a zigzag groove to improve the traction by increasing the axial component of the groove edges.

Preferably, the groove widths W1a, W1b and W1c of the main groove 3A, 3B and 3c, respectively are set in a range of from about 6 to 9 mm, and the maximum groove depths D1a, D1b and D1c of the main groove 3A, 3B and 3c, respectively are set in a range of from about 14 to 22 mm.

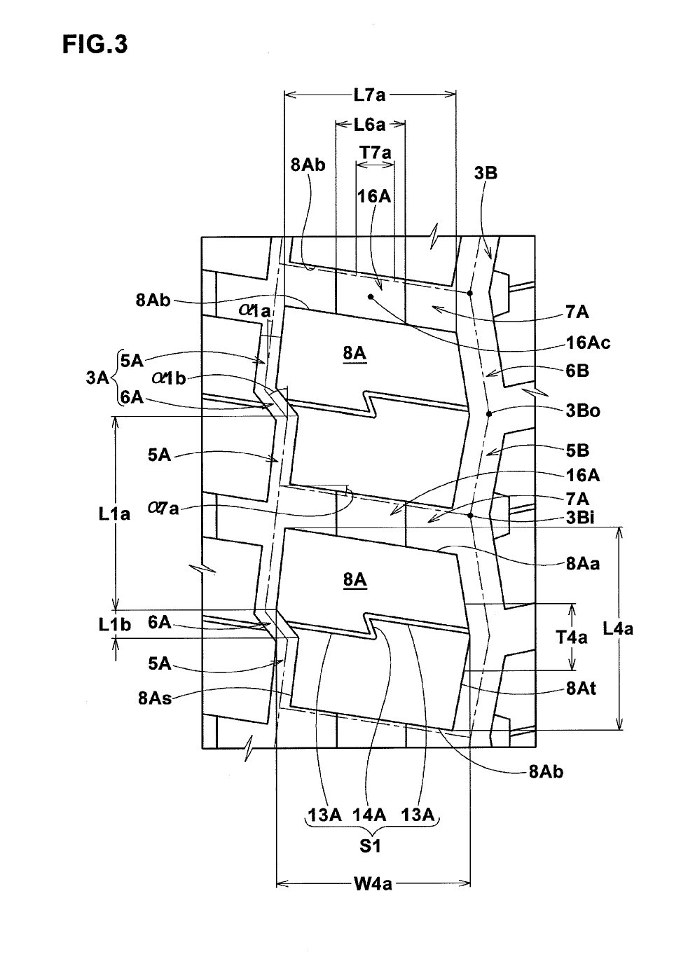

The center main groove 3A is as shown in FIG. 3, made up of mildly-inclined segments 5A inclined at an angle α1a of about 5 to 15 degrees with respect to the tire circumferential direction, and steeply-inclined segments 6A inclined at an angle α1b of about 30 to 50 degrees with respect to the tire circumferential direction, which are alternately arranged in the tire circumferential direction.

Preferably, the circumferential length L1a of the mildly-inclined segment 5A is more than 1 times, more preferably more than 5 times, but not more than 10 times the circumferential length L1b of the steeply-inclined segment 6A.

Therefore, the drainage in the circumferential direction and the traction can be achieved by the mildly-inclined longer segments 5A and the increased axial edge component due to the steeply-inclined segments 6A, respectively.

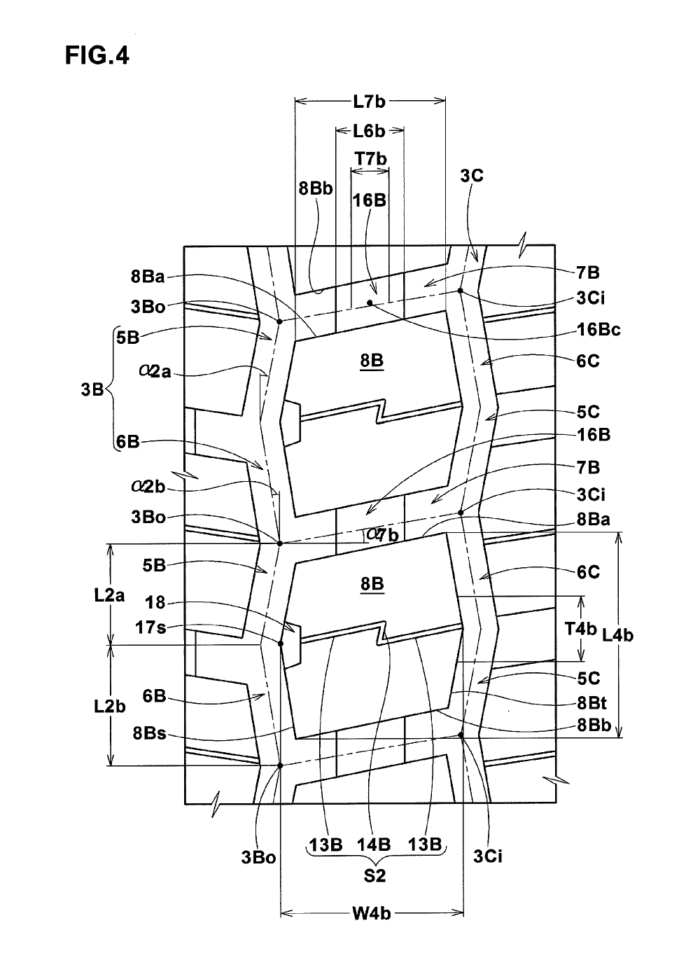

The middle main groove 3B is as shown in FIG. 4, made up of first oblique segments 5B inclined with respect to the tire circumferential direction toward one axial direction, and second oblique segments 6B inclined with respect to the tire circumferential direction toward the other axial direction, which are alternately arranged in the tire circumferential direction.

The circumferential length L2a and angle α2a with respect to the tire circumferential direction of the first oblique segment 5B are equal to the circumferential length L2b and angle α2b with respect to the tire circumferential direction of the second oblique segment 6B.

In order to achieve the drainage and the traction in a well balanced manner, it is preferred that the angles α2a and α2b are about 5 to 15 degrees, and the circumferential lengths L2a and L2b are about 40 to 60% of (L1a+L1b)/2 (one half of the sum of the above-mentioned lengths L1a and L1b).

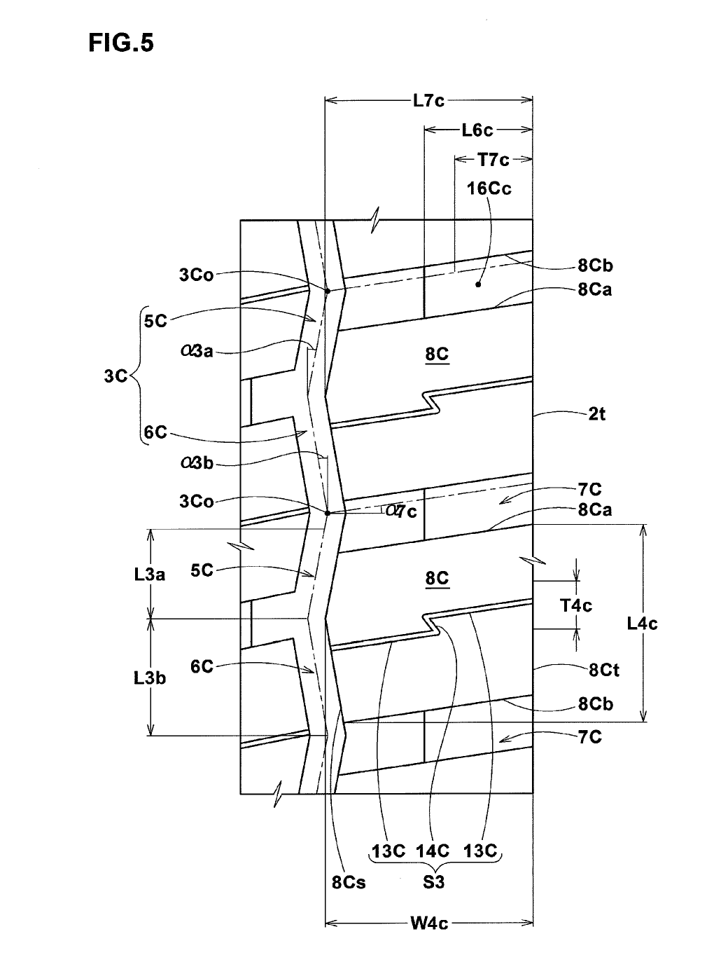

The shoulder main groove 3C is as shown in FIG. 5, made up of first oblique segments 5C inclined with respect to the tire circumferential direction toward one axial direction, and second oblique segments 6C inclined with respect to the tire circumferential direction toward the other axial direction, which are alternately arranged in the tire circumferential direction.

The circumferential length L3a and angle α3a with respect to the tire circumferential direction of the first oblique segment 5C are equal to the circumferential length L3b and angle α3b with respect to the tire circumferential direction of the second oblique segment 6C.

In order to achieve the drainage and the traction in a well balanced manner, it is preferable that the angles α3a and α3b are about 5 to 15 degrees, and the circumferential lengths L3a and L3b are about 40 to 60% of (L1a+L1b)/2.

In order to further improve the drainage and traction, the phase of zigzag of the shoulder main groove 3C is shifted from that of the middle main groove 3B by about one half of the zigzag pitch.

The crown land portion 4A is as shown in FIG. 1, provided with crown axial grooves 7A. The crown axial grooves 7A are circumferentially arranged at intervals and extend from the center main groove 3A to the middle main groove 3B, therefore, the crown land portion 4A is divided into a row of circumferentially arranged crown blocks 8A. The crown axial groove 7A extends at an inclination angle α7a of about 5 to 15 degrees with respect to the axial direction so as to connect between one of the axially inward vertexes 3Bi of zigzag of the middle main groove 3B and one of the mildly-inclined segments 5A of the center main groove 3A as shown in FIG. 3.

In view of the drainage and the traction, it is preferable that the crown axial groove 7A has a groove width W7a of about 14 to 17 mm and a maximum groove depth D7a of about 15 to 25 mm.

The edge 8As of the crown block 8A abutting on the center main groove 3A is a zigzag edge defined by edges of two mildly-inclined segments 5A and one steeply-inclined segment 6A therebetween. The edge 8At of the crown block 8A abutting on the middle main groove 3B is an axially outwardly protruding V-shaped edge defined by edges of one first oblique segment 5B and one second oblique segment 6B.

Therefore, the axial width W4a of the top face of the crown block 8A gradually increases from one block edge 8Aa in the tire circumferential direction toward the block center, whereas the axial width W4a is substantially constant from the opposite block edge 8Ab in the tire circumferential direction toward the block center. As a result, the crown block 8A can exert its circumferential and axial edge components to improve the traction and steering stability.

The crown block 8A is provided in its central region T4a in the tire circumferential direction with an axially extending sipe S1. The sipe S1 decreases the rigidity of the crown block 8A, and it is possible to decrease the rigidity variation of the crown land portion 4A along the tire circumferential direction, therefore, the occurrence of the center wear can be effectively prevented.

Here, the central region T4a of the crown block 8A is such region that has, at any axial position, a circumferential length of 35% of the maximum circumferential length L4a of the crown block 8A, and at any axial position, the midpoint of the circumferential length (35% of L4a) of the central region T4a coincides with the midpoint of the circumferential length of the crown block 8A.

In order to increase the edge length and thereby to increase the traction while preventing the center wear, the sipe S1 is Z-shaped and made up of a pair of major parts 13A which are staggered and extend from the block edges 8As and 8At in the tire axial direction toward the block center in parallel with each other, and a minor part 14A extending between the inner ends of the major parts 13A.

The maximum depth of the sipe S1 is preferably set in a range of from about 1 to 4 mm.

The middle land portion 4B is as shown in FIG. 1, provided with middle axial grooves 7B. The middle axial grooves 7B are circumferentially arranged at intervals and extend from the middle main groove 3B to the shoulder main groove 3c. Accordingly, the middle land portion 4B is divided into a row of circumferentially arranged middle blocks 8B.

The middle axial groove 7B connects between one of the axially outward vertexes 3Bo of zigzag of the middle main groove 3B, and one of the axially inward vertexes 3Ci of zigzag of the shoulder main groove 3C as shown in FIG. 4.

As shown in FIG. 1, the middle axial grooves 7B are circumferentially shifted from the axially adjacent crown axial grooves 7A by substantially a half pitch.

The middle axial grooves 7B are inclined oppositely to the axially adjacent crown axial grooves 7A.

Preferably, the middle axial groove 7B has a groove width W7b of about 5 to 20 mm, a maximum groove depth D7b of about 18 to 22 mm, and an inclination angle α7b of 5 to 15 degrees with respect to the axial direction. The middle axial grooves 7B help to improve the traction, steering stability and the drainage.

The edge 8Bs of the middle block 8B abutting on the middle main groove 3B is an axially inwardly protruding v-shaped edge defined by edges of one first oblique segment 5B and one second oblique segment 6B of the middle main groove 3B.

The edge 8Bt of the middle block 8B abutting on the shoulder main groove 3C is an axially outwardly protruding v-shaped edge defined by edges of one first oblique segment 5C and one second oblique segment 6c of the shoulder main groove 3C.

Therefore, the axial width W4b of the top face of the middle block 8B gradually increases toward the block center from both block edges 8Ba and 8Bb in the tire circumferential direction. As a result, the middle block 8B can exert its circumferential and axial edge components to improve the traction and steering stability.

The middle block 8B is provided at the axially inwardly protruding vertex 17s of the block edge 8Bs with a circumferentially-long indentation 18 by removing a certain rubber volume.

The indentation 18 reduces the rigidity of the middle block 8B in its axially inside part subjected to a relatively large ground pressure so as to prevent the heel-and-toe wear.

The middle block 8B is provided in its circumferential central region T4b with an axially extending sipe S2.

In order to increase the traction while preventing the heel-and-toe wear, the sipe S2 is z-shaped and made up of a pair of major parts 13B which are staggered and extend from the block edges 8Bs and 8Bt in the tire axial direction toward the block center in parallel with each other, and a minor part 14B extending between the inner ends of the major parts 13B.

The maximum depth of the sipe s2 is preferably set in a range of from about 1 to 4 mm.

Here, the central region T4b of the middle block 8B is such region that has, at any axial position, a circumferential length of 35% of the maximum circumferential length T4b of the middle block 8B, and at any axial position, the midpoint of the circumferential length (35% of L4a) of the central region T4b coincides with the midpoint of the circumferential length of the middle block 8B.

The shoulder land portion 4C is as shown in FIG. 1, provided with shoulder axial grooves 7C. The shoulder axial grooves 7C are circumferentially arranged at intervals so as to extend from the shoulder main groove 3C to the adjacent tread edge 2t. Accordingly, the shoulder land portion 4C is divided into a row of circumferentially arranged shoulder blocks 8C. As shown in FIG. 5, the shoulder axial groove 7C extends from one of the axially outwardly protruding vertexes 3Co of zigzag of the shoulder main groove 3C to the tread edge 2t, while inclining to the same direction as the middle axial grooves 7B.

As shown in FIG. 1, the shoulder axial grooves 7C are circumferentially sifted from the axially adjacent middle axial grooves 7B by substantially a half pitch.

The shoulder axial grooves 7C help to improve the traction, steering stability and drainage.

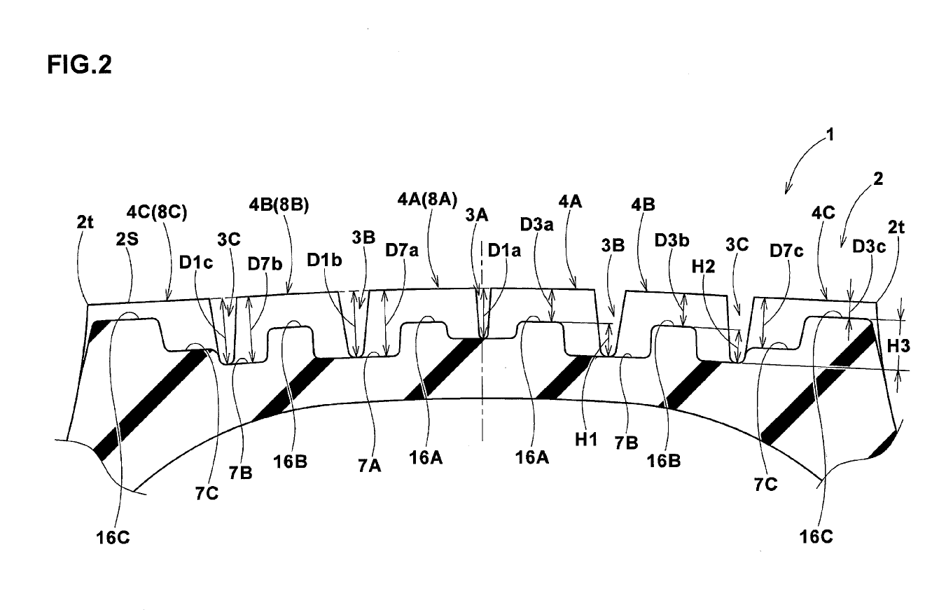

The maximum groove depth D7c of the shoulder axial grooves 7C is smaller than those of the crown axial grooves 7A and middle axial grooves 7B as shown in FIG. 2.

This can reduce the rigidity variation along the tire circumferential direction in the shoulder land portion 4C where the heel-and-toe wear is liable to occur in comparison with other land portions.

Preferably, the shoulder axial groove 7C has a groove width W7c of about 5 to 20 mm, a maximum groove depth D7c of about 14 to 17 mm, and an angle α7c of about 5 to 15 degrees with respect to the axial direction.

The edge 8Cs of the shoulder block 8C abutting on the shoulder main groove 3C is an axially inwardly protruding V-shaped edge defined by edges of one first oblique segment 5C and one second oblique segment 6C of the shoulder main groove 3C as shown in FIG. 5. The opposite edge 8Ct of the shoulder block 8C extends parallel to the tire circumferential direction, defining a part of the tread edge 2t.

Accordingly, the axial width W4c of the top face of the shoulder block 8C gradually increases toward the block center from both block edges 8Ca and 8Cb in the tire circumferential direction, and the traction and steering stability can be improved.

The shoulder block 8c is provided in its circumferential central region T4c with an axially extending sipe s3.

In order to increase the traction while preventing the heel-and-toe wear, the sipe S3 is z-shaped and made up of a pair of major parts 13C which are staggered and extend from the block edges 8Cs and 8Ct in the tire axial direction toward the block center in parallel with each other, and a minor part 14C extending between the inner ends of the major parts 13C.

The maximum depth D2c of the sipe S3 is preferably set in a range of from about 1 to 4 mm.

Here, the central region T4c of the shoulder block 8C is such region that has, at any axial position, a circumferential length of 35% of the maximum circumferential length T4c of the shoulder block 8C, and at any axial position, the midpoint of the circumferential length (35% of L4a) of the central region T4c coincides with the midpoint of the circumferential length of the shoulder block 8c.

According to the present invention, as shown in FIG. 1, the crown axial groove 7A, middle axial groove 7B and shoulder axial groove 7C are provided with a crown tie bar 16A, a middle tie bar 16B and a shoulder tie bar 16C, respectively.

The “protruding height” of a tie bar used in this application refers to the difference between the depth (minimum) of the axial groove measured at the tie bar's position and the depth (maximum) of the main groove adjacent to the axial groove. If the axial groove is adjacent to two main grooves and one is deeper than the other, the depth of the deeper main groove is used.

The crown tie bar 16A protrudes from the bottom of the crown axial groove 7A and connects the circumferentially adjacent crown blocks 8A as shown in FIG. 3.

The maximum protruding height H1 is preferably set in a range of not less than 30%, more preferably not less than 40%, but not more than 70%, more preferably not more than 60% of the maximum groove depth D1b of the middle main groove 3B.

The maximum axial length L6a of the crown tie bar 16A is preferably set in a range of not less than 30%, more preferably not less than 40%, but not more than 70%, more preferably not more than 60% of the maximum axial length L7a of the crown axial groove 7A.

Therefore, the crown tie bars 16A increase the circumferential rigidity of the crown land portion 4A, which helps to increase the traction and prevent the center wear. If the maximum protruding height H1 is more than 70%, the drainage performance is deteriorated.

In this embodiment, the maximum protruding height H1 is the difference between the depth D1b of the middle main groove 3B and the depth D1a of the crown axial groove 7A measured at the position of the crown tie bar 16A.

In the crown land portion 4A, there is a tendency that the center wear and heel-and-toe wear are accelerated its axial central region than side regions, therefore, it is preferable that the midpoint 16Ac of the maximum axial length of the crown tie bar 16A is positioned in an axial central part T7a of the crown axial groove 7A.

Here, the axial central part T7a of the crown axial groove 7A is defined as having an axial length of 35% of the maximum axial length L7a of the crown axial groove 7A and centered on the midpoint of the maximum axial length L7a.

Therefore, the crown tie bars 16A reduce the rigidity variation along the tire circumferential direction in the axial central region of the crown land portion 4A and the center wear is prevented.

The middle tie bar 16B protrudes from the bottom of the middle axial groove 7B and connects the circumferentially adjacent middle blocks 8B as shown in FIG. 4.

The maximum protruding height H2 is preferably set in a range of not less than 30%, more preferably not less than 40%, but not more than 70%, more preferably not more than 60% of the maximum groove depth D1b of the middle main groove 3B.

The maximum axial length L6b of the middle tie bar 16B is preferably set in a range of not less than 30%, more preferably not less than 40%, but not more than 70%, more preferably not more than 60% of the maximum axial length L7b of the middle axial groove 7B as shown in FIG. 4.

The middle tie bars 16B helps to improve the traction while preventing the heel-and-toe wear.

Preferably, the midpoint 16Bc of the maximum axial length of the middle tie bar 16B is positioned in an axial central part T7b of the middle axial groove 7B.

Here, the axial central part T7b of the middle axial groove 7B is defined as having an axial length of 35% of the maximum axial length L7b of the middle axial groove 7B and centered on the midpoint of the maximum axial length L7b.

Therefore, the middle tie bars 16B can prevent the heel-and-toe wear.

The shoulder tie bar 16C protrudes from the groove bottom of the shoulder axial groove 7C and connects the circumferentially adjacent shoulder blocks 8C as shown in FIG. 5. This helps to improve the traction while preventing the heel-and-toe wear. In comparison with the crown tie bar 16A and middle tie bar 16B, the maximum protruding height H3 of the shoulder tie bar 16C is largest.

The maximum protruding height H3 is preferably set in a range of not less than 70%, more preferably not less than 75%, but not more than 85%, more preferably not more than 80% of the maximum groove depth of the shoulder axial groove 7C.

The maximum axial length L6c of the shoulder tie bar 16C is preferably set in a range of not less than 30%, more preferably not less than 40%, but not more than 70%, more preferably not more than 60% of the maximum axial length L7c of the shoulder axial groove 7C.

Therefore, the shoulder tie bars 16C can effectively increase the rigidity of the shoulder land portion 4C where the heel-and-toe wear and shoulder wear are most liable to occur than any other. If the maximum protruding height H3 is more than 85%, the drainage performance is deteriorated.

In the shoulder land portion 4c, there is a tendency that the heel-and-toe wear and shoulder wear are accelerated its axial outer region than inner region, therefore, it is preferable that the midpoint 16Cc of the maximum axial length of the shoulder tie bar 16C is positioned in the axial outside region T7c of the shoulder axial groove 7C.

Here, the outside region T7c of the shoulder axial groove 7C is defined as having an axial length of 40% of the maximum axial length L7c of the shoulder axial groove 7c and extending from the tread edge 2t toward the axially inside.

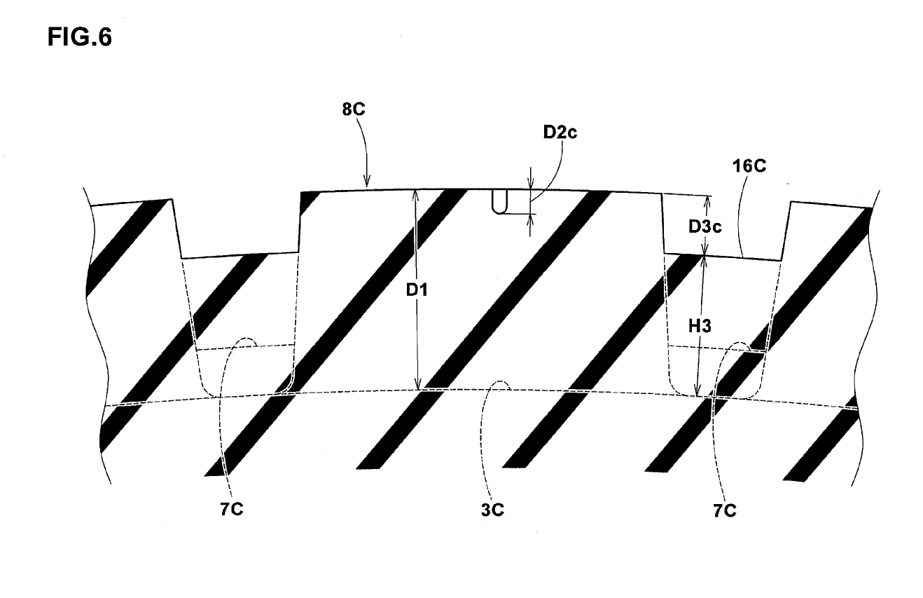

In order to decrease the rigidity variation in the shoulder land portion along the tire circumferential direction and thereby effectively reduce the heel-and-toe wear, the difference (D3c−D2c) of the shoulder axial groove depth D3c at the shoulder tie bar 16C from the maximum depth D2c of the sipe S3 of the shoulder block 8C is preferably set in a range of not more than 30%, more preferably not more than 20%, but not less than 10% of the maximum groove depth D1c of the shoulder main groove 3c as shown in FIG. 6.

If the ratio ((D3c−D2c)/D1c) is more than 30%, it becomes difficult to reduce the heel-and-toe wear. If the ratio (D3c−D2c)/D1c) is less than 10%, the mutual support between the shoulder blocks 8c decreases and there is a possibility that the heel-and-toe wear occurs.

Further, the maximum width Wcr of the crown land portion 4A (crown block 8A), the maximum width Wmi of the middle land portion 4B (middle block 8B), and the maximum width Wsh of the shoulder land portion 4C (shoulder block 8c) are set to satisfy the following conditions:

0.9=<Wmi/Wcr=<0.98 and

1.1=<Wsh/Wcr=<1.22.

Therefore, the rigidity of the crown blocks 8A whose ground pressure is relatively high is relatively increased and thereby the center wear is effectively reduced. As the rigidity of the shoulder blocks 8c is maintained, the heel-and-toe wear and shoulder wear can be prevented.

As the shoulder land portion 4C is formed in a relatively narrow width while securing the rigidity, the variation of the ground pressure in the tire axial direction can be reduced.

As the shoulder tie bar 16C is made larger than any other while relatively decreasing the width of the shoulder land portion 4C, the rigidity difference between the part supported by the tie bar and the part not supported is decreased, and the variation of the amount of wear in the widthwise direction of the shoulder land portion 4C is decreased, therefore, the occurrence of uneven wear can be effectively controlled.

As a result, the center wear and heel-and-toe wear are improved to high levels.

If the ratio (Wmi/Wcr) is more than 0.98, the rigidity of the crown blocks 8A decreases, and it becomes difficult to effectively prevent the center wear. If the ratio (Wmi/Wcr) is less than 0.9, the rigidity of the middle blocks 8B decreases, and it becomes difficult to fully prevent the heel-and-toe wear. From this standpoint, the ratio (Wmi/Wcr) is preferably set in a range of not more than 0.98, more preferably not more than 0.96, but not less than 0.9, more preferably not less than 0.92.

The ratio (Wsh/Wcr) is preferably set in a range of not more than 1.22, more preferably not more than 1.18, but not less than 1.10, more preferably not less than 1.14.

Further, it is preferable that, within the above-mentioned ranges, the ratio (Wmi/Wcr) and ratio (Wsh/Wcr) satisfy the following limitation (A) or alternatively (B):

(A) the ratio (Wmi/Wcr) is more than 0.94 and the ratio (Wsh/Wcr) is more than 1.16;
(B) the ratio (Wmi/Wcr) is less than 0.94 and the ratio (Wsh/Wcr) is less than 1.16.

This improves the rigidity balance between the middle blocks 8B and the shoulder blocks 8C, which helps to further improve the heel-and-toe wear.

If the ratio (Wmi/Wcr) is more than 0.94 and the ratio (Wsh/Wcr) is less than 1.16, then the rigidity difference between the middle blocks 8B and the shoulder blocks 8c is decreased, and it becomes difficult to prevent the heel-and-toe wear of the shoulder blocks 8C. If the ratio (Wmi/Wcr) is less than 0.94 and the ratio (Wsh/Wcr) is more than 1.16, then the rigidity difference between the middle blocks 8B and the shoulder blocks 8c is increased, and it becomes difficult to prevent the heel-and-toe wear of the middle blocks 8B.

### Comparison Tests

Based on the tread pattern shown in FIG. 1, test tires of size 11.00R20 (rim size: 20×8.00) having specifications shown in Table 1 were prepared and tested as follows.

Common specifications are as follows.

Center, middle and shoulder main grooves:

groove width W1a, W1b, W1c: 6 to 9 mm

maximum groove depth D1a, D1b, D1c: 20.4 mm

steeply-inclined segments:
angle α1a: 10 degrees
length L1a: 45 mm

mildly-inclined segments:
angle α1b: 40 degrees
length Lib: 5 mm
   first and second oblique segments:
angle α1a, α1b, α3a, α3b: 10 degrees
length L2a, L2b, L3a, L3b: 22 mm
   Crown, middle and shoulder axial grooves:
angle α7a, α7b, α7c: 10 degrees
groove width W7a, W7b, W7c: 5 to 20 mm
maximum groove depth D7a, D7b, D7c: 15.4 to 20.4 mm maximum length L7a, L7b, L7c: 20 to 50 mm
   Crown block:
maximum length L4a: 40 mm
central region T4a: 14 mm (35% of L4a)
   Middle block:
maximum length L4b: 42 mm
central region T4b: 14.7 mm (35% of L4b)

Shoulder block:
maximum length L4c: 40 mm
central region T4c: 14 mm (35% of L4c)

### Crown tie bar:

maximum groove depth D3a: 10.2 mm
maximum protruding height H1: 10.2 mm (50% of Dia)
maximum length L6a: 16 mm (50% of L7a)
central region T7a: 11.2 mm (35% of L7a)

### Middle tie bar:

maximum groove depth D3b: 10.2 mm
maximum protruding height H2: 10.2 mm (50% of D1b)
maximum length L6b: 16 mm (50% of L7b)
central region T7b: 11.2 mm (35% of L7b)

### Shoulder tie bar:

maximum length L6c: 20 mm (50% of L7c)
outside region T7c: 16 mm (40% of L7c)

### Sipes S1, S2:

maximum depth: 2.5 mm

### <Uneven Wear Test>

The test tires were installed on all wheels of 8-ton 2-2D truck, and the truck was run for 80000 km on public roads including highways and expressways under the full load condition. (tire pressure 780 kPa) Then, the amount of wear was measured at various positions.

As the center wear, the ratio of the maximum wear in the crown blocks to the maximum wear in the shoulder blocks was obtained from the measured values. Thus, the smaller the value, the better the center wear.

As the heel-and-toe wear of the shoulder block, the ratio of the difference between the wear at the heel-side edge and the wear at the toe-side edge of the shoulder block to the maximum groove depth of the shoulder main groove was obtained. Thus, the smaller the value, the better the heel-and-toe wear.

As the heel-and-toe wear of the middle block, the ratio of the difference between the wear at the heel-side edge and the wear at the toe-side edge of the middle block to the maximum groove depth of the middle main groove was obtained. Thus, the smaller the value, the better the heel-and-toe wear.

The results are shown in Table 1.

### <Wet Performance (Drainage) Test>

Before subjected to the above-mentioned uneven wear test, the truck was run on a wet asphalt road in a tire test course covered with about 1.4-1.6 mm depth water at a speed of 60 km, and in order to measure the running distance to stop, full braking was applied under such condition that the anti-lock brake system was turn on.

The measured distance is indicated in Table 1 by an index based on Embodiment tire Ex. 1 being 100, wherein the smaller value, the better the wet performance.

From the test results, it was confirmed that, according to the present invention, the center wear and heel-and-toe wear can be improved to high levels.

TABLE 1

| Tire | Ref. 1 | Ex. 1 | Ex. 2 | Ex. 3 | Ref. 2 | Ref. 3 | Ex. 4 |
|---|---|---|---|---|---|---|---|
| max. width Wcr (mm)of | 37 | 37 | 37 | 37 | 37 | 37 | 37 |
| crown land portion | | | | | | | |
| max. width Wmi (mm) of | 39.59 | 34.78 | 33.3 | 36.26 | 31.45 | 38.85 | 34.78 |
| middle land portion | | | | | | | |
| Wmi/Wcr | 1.07 | 0.94 | 0.90 | 0.98 | 0.85 | 1.05 | 0.94 |
| max. width Wsh (mm) of | 47.73 | 42.92 | 40.7 | 45.14 | 33.3 | 51.8 | 42.92 |
| shoulder land portion | | | | | | | |
| Wsh/Wcr | 1.29 | 1.16 | 1.10 | 1.22 | 0.90 | 1.40 | 1.16 |
| depth D1c(mm) of | 20.4 | 20.4 | 20.4 | 20.4 | 20.4 | 20.4 | 20.4 |
| shoulder main groove | | | | | | | |
| protruding height H3(mm) of | 8.16 | 16.32 | 16.32 | 16.32 | 16.32 | 16.32 | 19.38 |
| shoulder tie bar | | | | | | | |
| H3/D1c (%) | 40 | 80 | 80 | 80 | 80 | 80 | 95 |
| depth D3c (mm) at | 5 | 5 | 5 | 5 | 5 | 5 | 5 |
| shoulder tie bar | | | | | | | |
| depth D2c(mm) of | 2.5 | 2.5 | 2.5 | 2.5 | 2.5 | 2.5 | 2.5 |
| shoulder block sipe | | | | | | | |
| (D3c − D2c)/D1c (%) | 12 | 12 | 12 | 12 | 12 | 12 | 12 |
| position of crown tie bar | center | center | center | center | center | center | center |
| position of middle tie bar | center | center | center | center | center | center | center |
| position of shoulder tie bar | outside | outside | outside | outside | outside | outside | outside |
| center wear | 1.4 | 1.2 | 1.1 | 1.3 | 1.0 | 1.5 | 1.2 |
| heel&toe wear (middle block) | 0.08 | 0.15 | 0.17 | 0.13 | 0.20 | 0.09 | 0.15 |
| heel&toe wear (shoulder block) | 0.20 | 0.09 | 0.11 | 0.07 | 0.13 | 0.05 | 0.07 |
| wet performance | 90 | 100 | 100 | 100 | 100 | 100 | 110 |
| Tire | Ex. 5 | Ex. 6 | Ex. 7 | Ex. 8 | Ex. 9 | Ex. 10 | Ex. 11 |
| max. width Wcr (mm)of | 37 | 37 | 37 | 37 | 37 | 37 | 37 |
| crown land portion | | | | | | | |
| max. width Wmi (mm) of | 34.78 | 34.04 | 35.52 | 34.78 | 34.78 | 34.78 | 34.78 |
| middle land portion | | | | | | | |
| Wmi/Wcr | 0.94 | 0.92 | 0.96 | 0.94 | 0.94 | 0.94 | 0.94 |
| max. width Wsh (mm) of | 42.92 | 43.66 | 42.18 | 42.92 | 42.92 | 42.92 | 42.92 |
| shoulder land portion | | | | | | | |
| Wsh/Wcr | 1.16 | 1.18 | 1.14 | 1.16 | 1.16 | 1.16 | 1.16 |
| depth D1c(mm) of | 20.4 | 20.4 | 20.4 | 20.4 | 20.4 | 20.4 | 20.4 |
| shoulder main groove | | | | | | | |
| protruding height H3(mm) of | 12.24 | 16.32 | 16.32 | 16.32 | 16.32 | 18.32 | 11.32 |
| shoulder tie bar | | | | | | | |
| H3/D1c (%) | 60 | 80 | 80 | 80 | 80 | 90 | 55 |
| depth D3c (mm) at | 5 | 5 | 5 | 5 | 5 | 3 | 10 |
| shoulder tie bar | | | | | | | |
| depth D2c(mm) of | 2.5 | 2.5 | 2.5 | 2.5 | 2.5 | 2.5 | 2.5 |
| shoulder block sipe | | | | | | | |
| (D3c − D2c)/D1c (%) | 12 | 12 | 12 | 12 | 12 | 2 | 37 |
| position of crown tie bar | center | center | center | outside | center | center | center |
| position of middle tie bar | center | center | center | outside | center | center | center |
| position of shoulder tie bar | outside | outside | outside | outside | inside | outside | outside |
| center wear | 1.2 | 1.2 | 1.2 | 1.3 | 1.2 | 1.2 | 1.2 |
| heel&toe wear (middle block) | 0.15 | 0.10 | 0.08 | 0.16 | 0.15 | 0.15 | 0.15 |
| heel&toe wear (shoulder block) | 0.12 | 0.05 | 0.10 | 0.09 | 0.10 | 0.08 | 0.12 |
| wet performance | 95 | 100 | 100 | 100 | 100 | 107 | 93 |

1. A heavy duty pneumatic tire comprising
a tread portion provided with circumferentially continuously extending main grooves, which are a center main groove on the tire equator, a pair of middle main grooves one on each side of the center main groove, and a pair of shoulder main grooves one on the axially outside of each said middle main groove, so as to define a pair of crown land portions between the center main groove and the middle main grooves, a pair of middle land portions between the middle main grooves and the shoulder main grooves, and a pair of shoulder land portions between the shoulder main grooves and tread edges,
the crown land portions, the middle land portions and the shoulder land portions are divided into crown blocks, middle blocks and shoulder blocks, respectively, by crown axial grooves, middle axial grooves and shoulder axial grooves, respectively,
the crown axial grooves, the middle axial grooves and the shoulder axial grooves are provided with crown tie bars, middle tie bars and shoulder tie bars, respectively, wherein each tie bar protrudes from the groove bottom to connect the circumferentially adjacent blocks,
the shoulder tie bars are largest in the protruding height, and
the maximum width Wcr of the crown land portion,
the maximum width Wmi of the middle land portion, and
the maximum width Wsh of the shoulder land portion
satisfy the following conditions:
0.9=<Wmi/Wcr=<0.98 and
1.1=<Wsh/Wcr=<1.22.

2. The heavy duty pneumatic tire according to claim 1, wherein
the ratio Wsh/Wmi is 1.12 to 1.36.

3. The heavy duty pneumatic tire according to claim 1 or 2, wherein
the midpoint of the maximum axial length of the crown tie bar is positioned in an axial central part of the crown axial groove,
the midpoint of the maximum axial length of the middle tie bar is positioned in an axial central part of the middle axial groove, and
the midpoint of the maximum axial length of the shoulder tie bar is positioned in an axial outside part of the shoulder axial groove.

4. The heavy duty pneumatic tire according to claim 1, wherein
the maximum protruding height of the shoulder tie bar is 70 to 85% of the maximum groove depth of the shoulder main groove.

5. The heavy duty pneumatic tire according to claim 1, wherein
the crown blocks, the middle blocks and the shoulder blocks are each provided in a circumferential central region thereof with an axially extending sipe.

6. The heavy duty pneumatic tire according to claim 5, wherein
the difference between the shoulder lateral groove depth at the shoulder tie bar and the maximum depth of the sipe of the shoulder block is not less than 30% of the maximum groove depth of the shoulder main groove.
